(19) United States
(12) Patent Application Publication
(10) Pub. No.: US 2014/0366374 A1
(43) Pub. Date: Dec. 18, 2014

(54) METHOD FOR CLOSING COOLING AIR BORES

(71) Applicant: MTU Aero Engines AG, Munich (DE)

(72) Inventors: Markus WALTEMATHE, Hannover (DE); Tobias WENSKY, Hannover (DE)

(21) Appl. No.: 14/301,999

(22) Filed: Jun. 11, 2014

(30) Foreign Application Priority Data
Jun. 13, 2013 (DE) 102013211047.2

(51) Int. Cl. B23P 15/04; F01D 5/00

(52) U.S. Cl. CPC B23P 15/04; F01D 5/005
USPC 29/889.1; 29/889.71

(57) ABSTRACT

Disclosed is a method for the manufacture or repair of a blade of a turbomachine, which blade has cooling air bores. In a machining step the cooling air bores are temporarily closed for their protection, a dual-cure epoxy resin being used for closing.

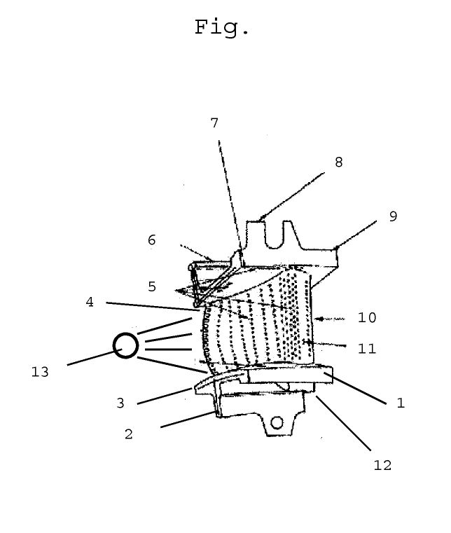

### CROSS-REFERENCE TO RELATED APPLICATIONS

The present application claims priority under 35 U.S.C. §119 of German Patent Application No. 102013211047.2, filed Jun. 13, 2013, the entire disclosure of which is expressly incorporated by reference herein.

### BACKGROUND OF THE INVENTION

1. Field of the Invention

The present invention relates to a method for the manufacture or repair of blades of a turbomachine and in particular a method for closing cooling air bores in order to protect them or the corresponding cooling air ducts during a machining step for manufacturing or repairing the blades of a turbomachine.

2. Discussion of Background Information

Blades of turbomachines, such as of static gas turbines or aero engines, are in part exposed to very high temperatures which make active cooling of the blades necessary. For example, in the high-pressure turbine, the turbine inlet temperature of the combustion gas from the combustion chamber is close to the melting temperature of the material from which the high-pressure turbine rotor blades are made, such that the high-pressure turbine rotor blades must be protected, on one hand by the application of ceramic thermal barrier layers and on the other hand by the provision of cooling air ducts so as to produce film cooling.

However, the simultaneous provision of coatings, such as thermal barrier layers on one hand and cooling air ducts on the other hand, on the blades of the turbomachine, makes the manufacture of such blades difficult and laborious since, for example, it must be ensured that sufficient flow can pass through the cooling air ducts for the delivery of cooling air to the cooling air openings of the blade airfoil even after application of a thermal barrier layer.

It is known, in this context, in the production of thermal barrier layers or in the repair of thermal barrier layers, to close or mask the cooling air ducts of the blades in order to ensure that the cooling air ducts are not closed or blocked by the coating process by means of which the thermal barrier layers are applied. Examples of this are given in WO 03/100 108 A1, EP 1 076 106 A1 and EP 0 816 635 A2, the entire disclosure of which are incorporated by reference herein.

EP 0 816 635 A2 describes applying a UV-curable plastic to the cooling air bores which are to be closed and curing this by means of UV (ultraviolet) radiation.

WO 03/100 108 A1 describes the application of a plastic which is provided with fillers and which can be cured for example also by means of UV radiation. However, since after closing the openings the thermal barrier layer has to be applied for example by thermal spraying, the closure material for the cooling air bores must be resistant to high temperatures, which occur during thermal spraying. The plastic material is accordingly thermally treated, after filling into the corresponding cooling air openings, such that the organic component is removed and the filler material remains as a temperature-resistant closure of the openings. In the case of this prior art, the UV-curable plastic can be introduced into the cooling air openings both from the surface of the blade airfoil or from a cavity inside the blade.

To that end, EP 1 076 106 A1 further proposes the provision, in the corresponding cavity of the blade airfoil, of a radiation source for curing the plastic, such that the curable plastic material can be applied from outside and cured from inside.

While the described methods can be used for closing cooling air openings before the application of the thermal barrier layer or in the case of a thermal barrier layer which is not yet present or which has already been entirely removed, there is an additional need to permit exact and defined closing of cooling air openings also such that cooling air bores in an already-applied thermal barrier layer can be finished without influencing the base material.

Although methods for closing cooling air openings in blades of turbomachines are thus already known, there is furthermore a need for a simple and efficient method which permits a defined closure of cooling air ducts and at the same time the finishing of cooling air ducts in thermal barrier layers.

It would therefore be advantageous to have available a method for closing cooling air bores which permits, in a simple and efficient manner, an exact and defined closure of cooling air bores, wherein in particular finishing of cooling air ducts in already-applied thermal barrier layers should be possible without adversely affecting the base material.

### SUMMARY OF THE INVENTION

The present invention provides a method for the manufacture or repair of a blade of a turbomachine, which blade comprises cooling air bores. The method comprises machining the blade and temporarily closing the cooling air bores during machining in order to protect the bores. In this method, a dual-cure epoxy resin is used for closing the bores.

In one aspect of the method, the dual-cure epoxy resin may undergo a first cure by radiation curing and a second cure by thermal curing or by reacting with a reaction partner. For example, the first cure may be effected by UV irradiation.

In another aspect of the method of the present invention, the dual-cure epoxy resin may comprise a cationic epoxy adhesive.

In yet another aspect, at least in one part of the cooling air bores, fluid resin may be introduced at a first end of the cooling air bores while the cooling air bores are irradiated with light at a second end of the cooling air bores, such that the resin cures and does not exit from the cooling air bores at their second end. For example, the second end of the cooling air bores may be located at outlet openings of the cooling air bores on a blade airfoil.

In a still further aspect of the method, the cooling air bores may be closed by the dual-cure epoxy resin after application of a thermal barrier layer.

In another aspect, ducts may be formed in a thermal barrier layer by laser drilling after closing the cooling air bores using the dual-cure epoxy resin.

In another aspect, the method may further comprise removing the dual-cure epoxy resin again from the cooling air bores by heating.

As set forth above, the present invention proposes, for closing cooling air bores, using a dual-cure epoxy resin such that an exact and defined closure of the cooling air bores is possible by means of a two-stage curing process (dual-cure).

A dual-cure epoxy resin of this type can undergo a first cure by means of radiation curing and a second cure by means of thermal curing or by reacting with a reaction partner, such as moisture from the surrounding atmosphere or similar.

In particular, a dual-cure epoxy resin in the form of a cationic epoxy adhesive can be used. A cationic polymerization is usually initiated using Lewis- or Brønsted-acids, which can be produced by means of prior chemical, in particular photochemical, reactions. Such photoinitiators may be formed by diazonium compounds, sulfonium compounds or iodonium compounds, which can for example be excited by means of ultraviolet light (in this regard see, for example, U.S. Pat. Nos. 3,205,157, 4,173,476, 4,264,703 and 4,394,403). Moreover, photoinitiators which work in the visible spectrum may also be used, such as arene cyclopentadienyl iron complexes (see, e.g., EP 0 094 915 A, WO 96/03453 and EP 0 661 324 A). Furthermore, other systems are known, as described for example in WO 95/14716, WO 96/13538, U.S. Pat. Nos. 5,554,676, 4,828,583, 4,256,828, 4,231,951, EP 0 119 425 B, DE 43 24 322 A and EP 0 897 710 A2. All cationic epoxy resins described in the above publications may be used in the context of the present invention and all of these publications are incorporated by reference herein.

In particular, it is possible to use a cationic epoxy adhesive the first cure of which can be effected by means of UV irradiation.

It is possible, by using dual-cure cationic epoxy resins, to introduce the fluid resin at a first end of the cooling air bores and to irradiate the resin at a second end of the cooling air bores using light, for example UV light, such that the resin cures in accordance with the first cure when it exits from the cooling air bores at the second ends thereof in the region of the blade airfoil. In this manner, it is possible to close the cooling air ducts in the region of the blade airfoil from within, in a defined manner, by introducing the resin into the cooling air ducts of a blade, since the epoxy resin can be irradiated with appropriate light as it exits from the cooling air openings, so that it cures. This first, light-induced cure can occur in a defined manner in the region where the first light hits, such that the closure of the cooling air ducts can occur with an inward offset. This means that, in an outer region, for example in the region of the thermal barrier layer, the cooling air ducts can be machined without inner regions of the cooling air ducts being adversely affected. For example, an already-applied thermal barrier layer can be finished in such a manner that the cooling air ducts are finished in the thermal barrier layer in order to set an exact cooling air duct geometry. Such a machining can for example be carried out by means of laser beams, wherein the cooling air ducts which are closed by means of the dual-cure epoxy resin protect the base material of the blade from being impaired by interaction with the laser beam.

Since the light used for the first cure of the dual-cure epoxy resin can enter the cooling air bores in a similar manner to the laser beams, the resin for closing the cooling air ducts can be cured in a defined manner in those regions in which the base material of the blade is to be protected before machining with the laser beams.

After a first cure using light, i.e. generally electromagnetic radiation and in particular using UV light, that is to say light in the ultraviolet wavelength spectrum, and closure of the ducts, the epoxy resin introduced into the cooling air ducts can be fully cured by means of a second cure, for example thermal curing, in order to achieve a strong and stable closure of the cooling air ducts and internal structures in hidden regions or undercuts. The laser material machining of the thermal barrier layer can then be carried out.

After machining the thermal barrier layer or generally after the end of the work, for which the cooling air ducts have been closed for their own protection, the dual-cure epoxy resin can be removed again from the cooling air ducts, for example by heating.

### BRIEF DESCRIPTION OF THE DRAWING

In the appended drawing, the FIGURE shows, purely schematically, a perspective representation of a blade of an aero engine which has been manufactured and machined according to the present invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

The appended FIG. shows a perspective representation of a blade, as can be for example used in aero engines. The blade has a blade airfoil 11, an inner shroud 3 with a root region 12, and an outer shroud 7. A multiplicity of cooling air ducts are arranged in the blade and extend from the root region 12 of the inner shroud 3 through the blade airfoil 11 to the cooling air openings 5 and to openings in the region of the outer shroud 7.

The blade has, at the inner shroud 3 in the root region 12, an inner forward root 1 and an inner rear root 2, while a forward outer root 8 and a rear outer root 6 are provided in the outer shroud region 7, such that the shroud 7 has a forward end face 9 in the region of the leading edge 10 of the blade airfoil. A trailing edge 4 is located opposite the leading edge 10 on the blade airfoil 11.

In the case of the blade shown in the FIG., the blade airfoil 11 is provided with a ceramic thermal barrier layer which has been applied to the blade airfoil 11 by means of a coating process. However, during the coating process, the cooling air openings 5 are partially closed or narrowed, such that they have to be widened or opened again in an appropriate finishing process in order to allow a sufficient throughflow of cooling air. This is carried out by laser drilling, wherein however, when machining the cooling air bores in the applied thermal barrier layer, the laser beams can penetrate as far as the base material of the blade airfoil 11, such that they can interact with the base material. This could lead to the base material being exposed to an undesired and impermissible thermal treatment by the laser beams, such that the cooling air openings must be closed, at least in the region of the base material of the blade airfoil, in order to avoid a corresponding interaction.

To that end, liquid, dual-cure epoxy resin is introduced into the openings of the cooling air ducts in the region of the outer shroud 7 and flows through the cooling air ducts inside the blade airfoil 11 as far as the cooling air openings 5.

Radiation sources 13, which irradiate the cooling air openings 5 in the region of the blade airfoil 11, are arranged in the region of the cooling air openings 5 on the blade airfoil 11. The radiation sources 13 can for example be UV light sources which irradiate the cooling air openings 5 in the region of the blade airfoil 11 with UV light.

When the dual-cure epoxy adhesive, which has been introduced into the cooling air ducts in the region of the outer shroud 7, reaches the cooling air openings 5 in the region of the blade airfoil 11, the dual-cure epoxy resin is cured on account of the irradiation and thus closes the cooling air openings 5 such that the fluid, dual-cure epoxy resin cannot exit from the cooling air openings 5 in the region of the blade airfoil 11.

Once the cooling air openings 5 or the cooling air ducts have been sufficiently and appropriately closed and filled with dual-cure plastic, the blade undergoes a thermal treatment in order to carry out a second cure of the dual-cure epoxy resin. For example, the blade can be aged in an oven at 100° C. for 60 minutes in order to achieve a corresponding curing of the dual-cure epoxy resin.

After the dual-cure epoxy resin has finally been cured by means of the second cure, the cooling air openings 5 in the thermal barrier layer can be finished by means of laser drilling without the risk of the laser beam initiating undesired and unintended material changes in the base material of the blade airfoil 11.

Once this finishing of the cooling air openings 5 in the region of the blade airfoil 11 is complete, the dual-cure epoxy adhesive is once again removed from the cooling air ducts and the cooling air openings by heating.

While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects.

Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method for the manufacture or repair of a blade of a turbomachine, which blade comprises cooling air bores, wherein the method comprises machining the blade and temporarily closing the cooling air bores during machining in order to protect the bores, a dual-cure epoxy resin being used for closing.

2. The method of claim 1, wherein the dual-cure epoxy resin undergoes a first cure by radiation curing and a second cure by thermal curing.

3. The method of claim 1, wherein the dual-cure epoxy resin undergoes a first cure by radiation curing and a second cure by reacting with a reaction partner.

4. The method of claim 1, wherein the dual-cure epoxy resin comprises a cationic epoxy adhesive.

5. The method of claim 2, wherein the dual-cure epoxy resin comprises a cationic epoxy adhesive.

6. The method of claim 3, wherein the dual-cure epoxy resin comprises a cationic epoxy adhesive.

7. The method of claim 2, wherein the first cure is effected by UV irradiation.

8. The method of claim 3, wherein the first cure is effected by UV irradiation.

9. The method of claim 1, wherein at least in one part of the cooling air bores, fluid resin is introduced at a first end of the cooling air bores while the cooling air bores are irradiated with light at a second end of the cooling air bores, such that the resin cures and does not exit from the cooling air bores at their second end.

10. The method of claim 9, wherein the second end of the cooling air bores is located at outlet openings of the cooling air bores on a blade airfoil.

11. The method of claim 1, wherein the cooling air bores are closed by the dual-cure epoxy resin after application of a thermal barrier layer.

12. The method of claim 1, wherein, after closing the cooling air bores using the dual-cure epoxy resin, ducts are formed in a thermal barrier layer by laser drilling.

13. The method of claim 11, wherein, after closing the cooling air bores using the dual-cure epoxy resin, ducts are formed in a thermal barrier layer by laser drilling.

14. The method of claim 1, wherein the method further comprises removing the dual-cure epoxy resin again from the cooling air bores by heating.

15. The method of claim 1, wherein the method further comprises removing the dual-cure epoxy resin again from the cooling air bores by heating.
